(19) United States
(12) Patent Application Publication
(10) Pub. No.: US 2011/0318126 A1
(43) Pub. Date: Dec. 29, 2011

(54) MACHINE DEVICE AND METHOD FOR ENSURING A PREDETERMINED MACHINING DEPTH

(75) Inventors: Peter Cornelius, Kasel (DE); Matthias Eisner, Enkirchen (DE); Thomas Hahn, Nonnweiler-Kastel (DE); Stefan Kaiser, Wadrill (DE); Helmut Kasper, Wadern (DE); Artur Klink, Saarbrucken (DE); Michael Klos, St. Wendel (DE); Christoph Olaineck, Trier (DE); Michael Schultz, Eppelborn (DE)

(73) Assignee: THYSSENKRUPP SYSTEM ENGINEERING GMBH, Heilbronn (DE)

(21) Appl. No.: 13/254,592

(22) PCT Filed: Jan. 14, 2010
(86) PCT No.: PCT/EP2010/000145

§ 371 Date: Sep. 6, 2011

(30) Foreign Application Priority Data
Mar. 6, 2009 (DE) 10 2009 012 154.4

(51) Int. Cl. B23B 39/14; B23Q 17/22; B23Q 17/24; B23B 49/00

(52) U.S. Cl. 408/1 R; 408/129

(57) ABSTRACT

The invention relates to a machining device for machining a workpiece (W), wherein a rotatably mounted machining tool (2a) is held in a machining unit (2), and the machining unit (2) can be moved axially along the axis of rotation (X) of the machining tool (2a) by means of a feed device (10). The machining device comprises a pressure plate (6), mounted in a freely movable manner by means of a bearing device (4), and a measuring device (8) for position detection. According to the invention, the pressure plate (6) and the bearing device (4) constitute part of a pressure-exerting unit (12), and the pressure-exerting unit (12) can be moved axially with respect to the machining unit (2) in the direction of the axis of rotation (X) and independently of the machining unit (2) by means of a drive device (14) assigned to said pressure-exerting unit.

The invention relates to a processing device for processing a workpiece (in particular a workpiece fixed in a support device, such as a clamping frame or the like for the duration of the processing). The processing device is advantageously formed as an at least partly automated drilling device which can be disposed on a robot arm and can be aligned (in an automated manner) with its drilling tool orthogonal to a surface point on the workpiece surface to be processed, in order to be able to drill holes for example, whose bore axis coincides with the surface normal in the bore hole centre point on the processing surface (bores of orthogonal holes). For this purpose, the processing device comprises on the head side a pressure plate which is mounted so as to be freely movable via a bearing device (360° about the rotational axis of the processing tool at all tipping points). A measuring device detects any alignment/position deviation of the pressure plate occurring when the pressure plate is pressed against the workpiece surface to be processed—departing from a central position in which the central axis of a through-going opening in the pressure plate, extending as a surface normal of the pressure plate, and the rotational axis of the processing tool coincide.

Such an apparatus is already known from patent document U.S. Pat. No. 5,848,859. This document describes a drilling tool which likewise comprises a drilling machine mounted in a drilling machine housing and on whose head-side end a freely movable pressure foot is formed which on the bearing side comprises a (spherical) bearing surface which is formed as a circular segment as seen in cross-section and co-operates with a (spherical) surface in the drilling machine housing corresponding thereto. The pressure foot is kept biased and in a defined starting position with respect to the drilling machine housing via individual retaining springs. Tipping of the pressure foot—e.g., caused by placement of the drilling foot on a workpiece surface which is positioned so as not to be orthogonal to the bore axis—is detected by a plurality of laterally disposed linear path measuring sensors which means that upon tipping of the pressure foot a control device for a robot arm bearing the drilling device causes the robot arm to be controlled/moved such that orthogonal alignment of the drilling tool with respect to the surface to be drilled is effected. As soon as the drilling machine has reached the desired orthogonal drilling position at the drilling point of the workpiece, the drilling machine is moved via a feed device allocated thereto in order to effect corresponding drilling.

The object of the present invention is to provide a processing device of the generic type which is improved in terms of maintaining predetermined processing depths in the workpiece to be processed. In particular, the metering of the pressing pressure, by means of which the pressure plate is to be pressed against a workpiece surface to be processed, is to be improved. In particular in the case of workpieces to be processed which are supported indirectly against a working surface from their rear side, improved processing is hereby to be achieved. If for example a support surface covering, which is supported against a support surface rib of an inner support surface frame from its rear side, is to be processed—approximately such that the support surface covering and also the support surface rib lying thereunder should be drilled through at a predetermined processing point and should then be connected together possibly by a rivet connection—it is helpful to ensure that the two workpiece parts to be drilled through lie against each other via a defined pressing pressure.

In accordance with the invention, this object is achieved by the features of Claim 1 taken as a whole. Advantageous developments of the invention are described in the subordinate Claims. In accordance with the present invention, it is proposed to combine—in addition to a feed device for driving the processing unit along the bore axis—the pressure plate together with its bearing device in a structural unit (pressure unit) and to form this unit so it can move along the bore axis via a further linear drive device. The drive device of the pressure unit is designed to be axially displaceable relative to and independent of the feed device or of the processing unit which can be displaced by the feed device. Owing to these two drive devices which are decoupled from each other, the axial positioning of the drilling tool can be implemented in a more precise manner. Hydraulically or pneumatically driven precision drives are particularly provided as the linear drive device for the processing unit and/or for the pressure unit. In order to calibrate the processing unit, which is formed in particular as a drilling machine, in terms of its feed or in terms of the processing depth in the workpiece achieved by the feed, a corresponding position detecting device is provided. The precise axial position of the drilling tool (in particular the position when the drilling or processing unit is in the rest position) can be determined prior to each drilling process, but in particular at least after each time the tool is replaced, via the position detecting device which is advantageously formed as a light barrier. For this purpose, the processing unit is moved, starting from a predetermined rest position in which the feed device and the drive device of the pressure unit are in a defined starting position, into a calibration position, wherein the position detecting device, which is disposed in a positionally-fixed manner relative to the feed device, determines when this calibration position has been reached. Since the axial distance between the position detecting device, disposed in a positionally-fixed manner, and the surface of the pressure plate contacting the workpiece to be processed is set within constructional restraints and is therefore known, the covered displacement path between the rest position and the calibration position can be determined (measured) which means that in dependence upon the known distance between the position detecting device and the contact surface of the pressure plate, and also in dependence upon the covered displacement path between the rest position and the calibration position, as well as in consideration of the desired processing depth, the required total displacement path (total feed) for the processing unit in the direction of the workpiece to be processed [can] be determined. The total displacement path is understood to mean in particular the displacement path for the processing unit which is understood to mean the path starting from the defined rest position to the end position in which the processing tool has processed the workpiece with the desired processing depth. Further advantages, features and expedient developments of the invention are discussed in the following description of the Figures, in which:

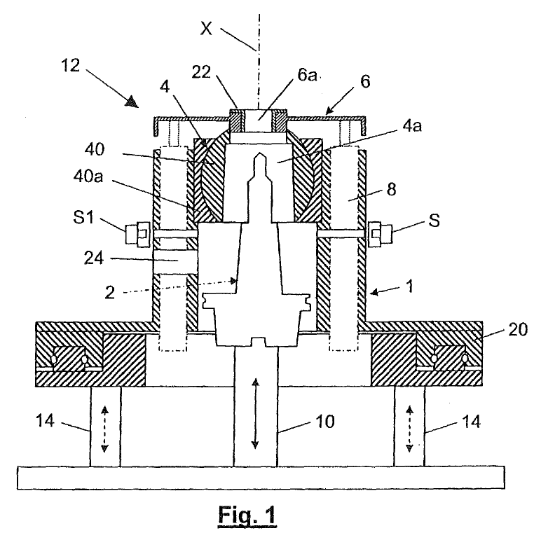

FIG. 1 shows a schematic illustration of the processing device in accordance with the invention having a processing unit formed as a drilling unit,

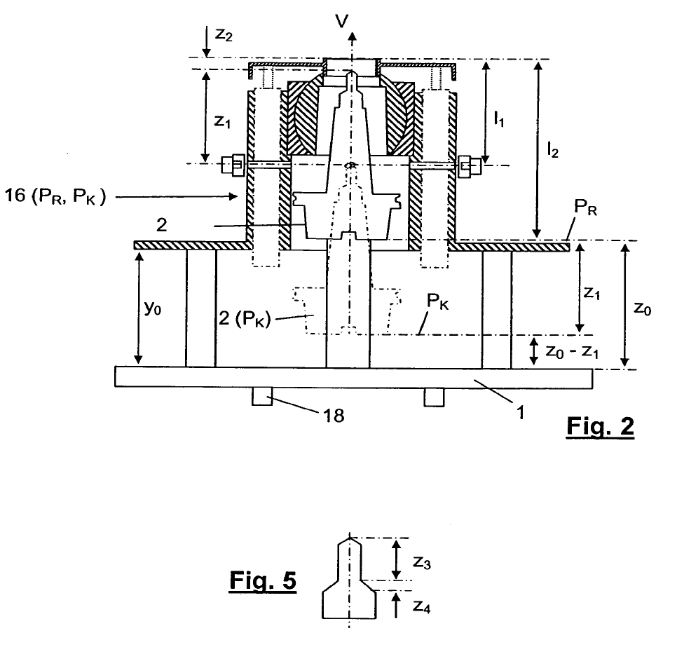

FIG. 2 shows the processing device of FIG. 1, wherein the processing unit is shown in a first possible rest position,

FIG. 3 shows the processing device of FIG. 1, wherein the processing unit is shown in a second possible rest position,

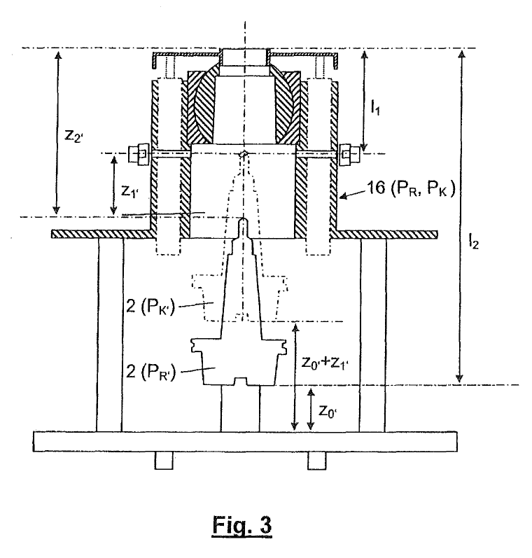

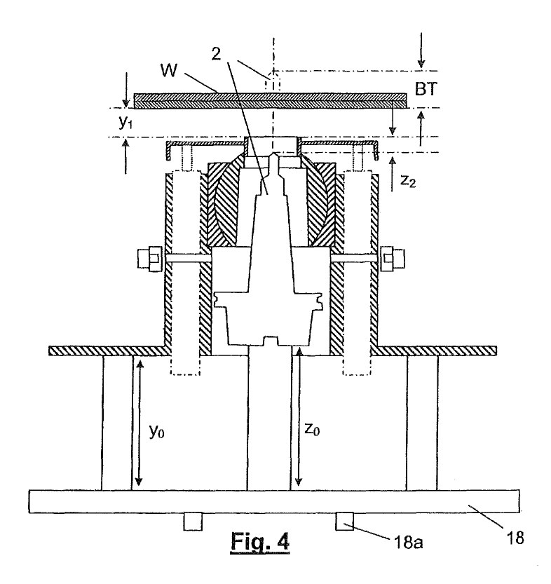

FIG. 4 shows the processing device of FIG. 1, wherein this is pre-positioned at a spaced disposition with respect to the workpiece to be processed, and

FIG. 5 shows the sectional illustration of a processing tool supported by the processing unit.

By means of the processing device in accordance with the invention or using the method in accordance with the invention for the automated determining of a total displacement path of a processing unit for ensuring a predetermined processing depth, in particular large components, such as those used in aircraft manufacturing, should be machined using a robot-guided drilling head so that countersunk bores can be incorporated into the workpiece to be processed with a degree of precision of ±15 μm. For this purpose, imprecisions when positioning the robot and imprecisions in the positioning of the component to be processed as well as tolerances of this component have to be automatically compensated for. Furthermore, batch deviations of the rivets used or the like have to be compensated for.

FIG. 1 illustrates a processing device in accordance with the invention for processing a workpiece, wherein a processing unit 2 in the form of a drilling machine is used. The drilling machine 2 is disposed/mounted so as to be able to be axially displaced along the rotational axis X (or feed axis) of the processing tool 2a via a feed device 10. The processing unit 2 can be moved in a linear reciprocating manner via the feed device 10 with respect to a base plate 18 which is disposed in a positionally-fixed manner (the base plate is the positionally-fixed component of the processing device 2). The positionally-fixed base plate 18 can be designed as a separate plate (positioned perpendicularly to the feed axis) which can be attached to an attachment plane of a robot arm. Disposed coaxial to the processing unit 2 is a pressure unit 12 which, on its side facing a workpiece to be processed, supports a pressure plate 6 mounted via a bearing device 4 (spherical joint) and co-operates with a further drive device 14 on its side remote from the workpiece to be processed such that the pressure unit 12 can be axially displaced via the drive device 14 allocated thereto with respect to the processing unit 2 or relative thereto in the direction of the rotational axis X and independent of the processing unit 2 or the feed device 10. Disposed between the spherically mounted pressure plate 6 and the pressure unit 12 are several measuring sensors of a measuring device 8 in order to detect an alignment/tipping (or the degree and direction of tipping/alignment) of the pressure plate 6 upon being pressed onto a workpiece surface to be processed. The measuring sensors are not mechanically connected to the pressure plate 6 but rather lie against it merely on the rear side of the pressure plate 6 with a predetermined low spring force. The spring force is measured (proportionally to the mass of the pressure plate) such that although the measuring sensors lie against the pressure plate 6, they are not able to move it (the pressure plate 6 can thus not he moved or even aligned into a predetermined position by the spring-loaded measuring sensors). In order to achieve alignment and position detection of the pressure plate 6 in as precise a manner free of disruption and influences as possible, the pressure plate is mounted substantially free of forces to the extent that no force accumulators act on the pressure plate 6 (with the exception of the spring-loaded measuring sensors having a low force effect) in order to align it in a non-loaded state into a predetermined position—such as the central position—or to keep it in this position. In order to mount the pressure plate 6, the pressure unit 12 comprises a substantially hollow-cylindrical support frame 16 which, on its side remote from the workpiece (or the side facing the base plate 18), comprises a cap collar-like protrusion which means that, as seen in cross-section, a double L shape is formed, wherein the long limbs of the Ls lie opposite each other in parallel and wherein the short limbs of the Ls point outwards in opposite directions. The measuring sensors 8 are accommodated in the support frame 16 or are integrated therein at least in regions. This produces on the one hand an extremely compact construction and on the other hand the measuring sensors 8 are protected against mechanical influences or other influences. As a further protective measure for the measuring sensors 8, provision is made for an anti-rotation device (not illustrated) of the pressure plate 6. This anti-rotation device consists substantially of a ball which runs in a groove of a lateral surface of the pressure plate 6 and which is attached to a pin having a small diameter and is supported via this pin on the support frame 16 or on another component which is positionally-fixed relative to the pressure plate 6.

Furthermore, disposed opposite each other on the hollow-cylindrical region of the support frame 16 of the pressure unit 12 are two corresponding light barrier elements S1, S2 by means of which the position of the processing tool 2a is to be detected. The position is determined for example by detecting the tip of the processing tool 2a and this serves in particular to determine a drilling or countersinking depth to be achieved in the workpiece to be processed. The position is determined once at least after each time the tool is replaced at the beginning of a start-up procedure. For this purpose, the processing unit 2 with the processing tool 2a supported thereby is moved backwards starting from a rest position illustrated in FIG. 1 until the tip of the processing tool 2a (e.g., cross-cutter of a spiral drill) leaves the region of the light barrier elements S1, S2 (light barrier no longer interrupted) and is then slowly moved forwards until the light barrier of the light barrier elements S1, S2 is broken by the tip of the processing tool 2a. Owing to the defined position (known distance of the light barrier to the end surface of the pressure plate 6 or to the end surface of the pressing element 22—hereinafter also referred to as free travel) of the light barrier elements S1, S2 to the end surface of the spherically mounted pressure plate 6, the corresponding drilling or countersinking depth can be determined in a simple manner (drilling or processing depth=total feed travel−free travel; or feed travel required for the desired processing depth=free travel+desired processing depth).

In order for the position determination or the relative position of the processing tool 2a (defined by its rotational axis X) to the surface normal N to be able to be precisely determined at the point of the workpiece surface to be processed, the pressure plate 6 is formed such that a defined arrangement of the pressure plate 6 as close as possible to the surface position to be processed is effected. For this purpose, the through-going opening 6a in the pressure plate 6 is dimensioned so as to be adapted to the processing tool 2a to be passed through this opening 6a (e.g., through-going opening in the pressure plate 6 or pressing element 22 is only slightly greater than the diameter of the processing tool). On its side facing the workpiece to be processed, the pressure plate 6 advantageously comprises a pressing element 22 in the region of the through-going opening 6a. This pressing element 22 is preferably attached to the pressure plate 6 in a replaceable manner and consists for example of materials such as Teflon, metal, synthetic material or a ceramic material. The material for the pressing element 22 is selected in dependence upon the material of the workpiece to be processed and/or in dependence upon its surface qualities. The pressing element 22 can be accordingly structured on its surface facing the workpiece so that contact with the workpiece to be processed only occurs in the region of predetermined elevations. Furthermore, the pressing element 22 can also consist of individual segment parts, in particular of segment parts of a circular ring.

In order to be able to ensure that the processing tool 2a can be replaced as conveniently as possible (e.g., replacing a drill by a countersinking drill or a drill having another diameter), the pressure unit 12 is formed accordingly. For this purpose, the support frame 16 can be displaced for example with respect to its drive device 14 or with its drive device 14 transverse to the rotational axis X of the processing tool 2a via a rail guide 20. Alternatively, it is also feasible for the support frame 16 to be mounted in a pivotable manner transverse to the rotational axis X of the processing tool 2a via a hinge or a corresponding joint connection—not illustrated.

FIG. 2 illustrates the processing device in accordance with the invention in a rest position P_{R} in which the feed device 10 for driving the processing device 2 and also the drive device 14 for driving the pressure unit 12 are in a defined starting position. In the predetermined rest position P_{R} the pressure unit 12 is at a predetermined rest distance yₒ to the positionally-fixed pressure plate 18 of the processing device with a defined axial reference point (in this case formed by the circular ring-shaped surface of the support frame device 16 or the short limb(s) of the hollow-cylindrical support frame device 16 formed in a double L shape as seen in cross-section). Simultaneously, the processing unit 2 is at a predetermined rest distance z₀ to the base plate 18 of the processing device with a defined axial reference point (in this case formed by the end-side surface of the processing device 2). Starting from this defined rest position P_{R}, the processing unit 2 is displaced, together with the processing tool 2a supported thereby, into a calibration position P_{K} via the drive device (feed device 10) allocated thereto. The calibration position P_{K} is defined by a position detecting device S1, S2 formed as a light barrier and integrated into the support frame 16, wherein a predetermined feature of the processing device 2 and/or of the processing tool 2a is monitored or detected via the position detecting device S1, S2. In the illustrated exemplified embodiment, the cross-cutter of the processing tool 2a formed as a drill is detected via two light barrier elements S1, S2 for this purpose. The processing unit 2—when the pressure unit 12 is stationary or remains in its rest position—is displaced backwards for this purpose starting from its rest position, in which the tip of the processing tool 2a is located axially downstream of the light barrier elements S1, S2 as seen in the feed direction, until the light barrier interrupted in the rest state of the processing unit 2 is closed. In a preferred embodiment, for this purpose the processing unit 2 is displaced backwards at a first displacement speed v₁ past the calibration position P_{K} defined by the position detecting device S1, S2 and is then displaced forwards at a second displacement speed v₂ which is lower than the first displacement speed v₁ until the calibration position P_{K} is reached in accordance with the information from the position detecting device S1, S2 (light barrier interrupted) (dashed unfilled illustration of the processing tool 2 in the position z₀−z₁). In dependence upon the known distance I₁ between the position detecting device S1, S2 and the contact surface of the pressure plate 6 as well as in dependence upon the covered displacement path between the rest position P_{R} and the calibration position P_{K} as well as in consideration of the predetermined desired processing depth BT, the required total displacement path (total feed) for the processing unit 2 in the direction of the workpiece to be processed can be determined and therefore a high degree of accuracy can be ensured with regard to the processing depth BT to be produced in the workpiece.

FIG. 3 illustrates an embodiment of the invention different from that in FIG. 2, wherein the processing unit 2 is arranged in its rest position P_{R}′ with the tip of its processing tool 2a upstream of the position detecting device S1, S2 as seen in the feed direction V. Starting from this rest position P_{R}′, the position can be detected in a similar manner to the position detection described in accordance with FIG. 2, in that the processing device 2 is firstly displaced forwards beyond the calibration position P_{R} at a first displacement speed v₁ and is then displaced backwards at a second displacement speed v₂ which is lower than the first displacement speed v₁ until the calibration position P_{K} is reached in accordance with the information from the position detecting device S1, S2 (light barrier closed). The total displacement path is also determined in a similar manner to the process described in accordance with FIG. 2.

The method in accordance with the invention will now be briefly described with the aid of FIG. 4 which illustrates the processing device in accordance with the invention spaced apart from a workpiece W to be processed in the described rest position P_{R}. In the illustrated operating position, the processing device in accordance with the invention, which is held on a robot arm of an industrial robot—not illustrated—via the fastening means 18a formed on the base plate 18, is illustrated at an axial distance Y₁ (distance between contact surface of the pressure plate 6 and the surface of a workpiece W to be processed). The workpiece W to be processed consists for example of two pre-positioned, plate-like workpiece parts, which are to be permanently connected together, of an extensive component, such as an aircraft support surface or the like. The pressure unit 12 is now displaced, from the illustrated operating position in which the processing device in accordance with the invention has already been guided via a robot into a predetermined position with regard to the workpiece W to be processed, forwards in the feed direction V via the drive device 14 allocated thereto until the pressure plate 6 lies with its contact surface against the surface to be processed of the workpiece W with a predetermined pressing force. In order to determine the corresponding pressure forces, the processing device is fitted with a force sensor, not illustrated. Since the drive device 14 of the pressure unit 12—and thus also the pressure unit 12 itself—is now no longer in a starting position defined by rest position P_{R} but has rather changed by the distance y₁ (distance between pressure plate surface and workpiece surface=feed displacement path of the drive device 14), the relative position of the processing unit 2 disposed within the pressure unit 12 has also changed accordingly. However, since the original position of the processing tool 2a within the pressure unit 12 is known from the previously described calibration processes, only the additional displacement path y₁ needs to be considered for the total path to be covered which means that the drilling unit 2 [can] now be displaced by a total displacement path z total=z₀+z₂+y₁+desired drilling depth (BT), z₀ is the known distance of the processing unit 2 to the base plate 18 in the rest position; y₁ is the determined displacement path of the pressure unit 12 in the feed direction by the displacement thereof in the feed direction until the pressure plate 6 contacts the surface of the workpiece W; and z₂ is the known distance of the tip of the processing tool 2a to the contact surface of the pressure plate 6; and BT is the predetermined value for a desired processing depth (e.g., drilling and/or countersinking depth).

FIG. 5 illustrates the sectional view of the tip of a processing tool 2a designed as a countersinking drill. The processing path of the processing tool 2a is shown in a drilling processing path with the length z₃ and in a countersinking processing path with the length z₄. By means of the processing device in accordance with the invention or the method in accordance with the invention, extremely precise drilling or countersinking bore holes can be performed in workpieces—in the case of a known geometry of the processing tool 2a and by the required total displacement path of the processing unit 2 determined in accordance with the invention.

1. Processing device for processing a workpiece (W), wherein a processing tool (2a), which is mounted so as to be able to rotate, is held in a processing unit (2), and the processing unit (2) can be axially displaced along the rotational axis (X) of the processing tool (2a) via a feed device (10),
comprising
a pressure plate (6) which is mounted so as to be freely movable via a bearing device (4), wherein the bearing device (4) and also the pressure plate (6) both have a through-going opening (4a; 6a) for the processing tool (2a), and
a measuring device (8) for detecting the position of the pressure plate (6) which is aligned by being pressed against the workpiece surface,
characterised in that
the pressure plate (6) and the bearing device (4) are components of a pressure unit (12),
and the pressure unit (12) can be axially displaced along the rotational axis (X) via a drive device (14) allocated thereto relative to and independent of the processing unit (2).

2. Processing device as claimed in claim 1, characterised in that the measuring device (8) is formed such that the position deviation of the pressure plate (6) relative to a central position, in which the central axis of the through-going opening (6a), extending as a surface normal (N) of the pressure plate (6), and the rotational axis (X) of the processing tool (2a) coincide, is determined

3. Processing device as claimed in claim 1, characterised in that the pressure unit (12) comprises a position detecting device (S1, S2) for detecting the axial position of the processing tool (2a).

4. Processing device as claimed in claim 3, characterised in that the position detecting device (S1, S2) is designed as a light barrier.

5. Processing device as claimed in claim 3, characterised in that the position detecting device (S1, S2) is formed such that positionally-accurate detection of the tip of the processing tool (2a) and/or of a predetermined marking on the processing tool (2a) is possible.

6. Processing device as claimed in claim 1, characterised in that the bearing device (4) is designed as a spherical joint bearing which comprises a bearing body (40b), comprising at least one spherical surface region, and a bearing receptacle (40a) surrounding the bearing body (40b) in a positive-locking manner at the spherical surface regions.

7. Method for the automated determination of a total displacement path of a processing unit (2) for ensuring a predetermined processing depth in a workpiece which is processed by means of a processing device formed in accordance with any one of the preceding Claims, comprising the following method steps:
i) starting from a predetermined rest position (P_{R}) in which the feed device (10) and the drive device (14) of the pressure unit (12) are in a defined starting position,
the processing unit (2), together with the processing tool (2a) is displaced into a calibration position (P_{K}) via the feed device (10), wherein a positionally-fixed position detecting device (S1, S2) at a known axial distance (I1) to the contact surface of the pressure plate (6) determines when the calibration position (P_{K}) has been reached,
and the covered displacement path (z₁; z₁′) between the rest position (P_{R}) and the calibration position (P_{K}) is determined and
ii) in dependence upon the known distance (I₁) and in dependence upon the covered displacement path (z₁; z₁′) and in consideration of the desired processing depth (BT), the total displacement path for the processing unit (2) in the direction of the workpiece (W) to be processed is determined

8. Method as claimed in claim 7, characterised in that the position detecting device (S1, S2) is formed as a light barrier and the position is detected by evaluating the light barrier signals.

9. Method as claimed in claim 7, characterised in that the calibration position (P_{K}) is reached by detecting a predetermined feature of the processing tool (2a).

10. Method as claimed in claim 9, characterised in that calibration position (P_{K}) is reached by detecting the tip of the processing tool (2a)—in particular by detecting the cross-cutter of a processing tool (2a) formed as a drilling tool.

11. Method as claimed in claim 7, characterised in that the rest position (P_{R}) of the processing device (2) is upstream of the position detecting device (S1, S2) as seen in the feed direction (V) and the processing device (2) is displaced in the feed direction (V) starting from the rest position (P_{R}) in order to reach the calibration position (P_{K}).

12. Method as claimed in claim 7, characterised in that the rest position (P_{R}) of the processing device (2) is downstream of the position detecting device (S1, S2) as seen in the feed direction (V) and the processing device (2) is displaced in the direction opposite the feed direction (V) starting from the rest position (P_{R}) in order to reach the calibration position (P_{K}).

13. Method as claimed in claim 12, characterised in that the position is detected with regard to when the calibration position (P_{K}) has been reached, in that the processing device (2) is first displaced beyond the calibration position (P_{K}) in the direction opposite the feed direction (V) at a first displacement speed (v₁), and is then displaced in the feed direction (V) at a second displacement speed (v₂) which is lower than the first displacement speed (v₁) until it reaches the calibration position (P_{K}) in accordance with information from the position detecting device (S1, S2).
